(19) United States
(12) Patent Application Publication
(10) Pub. No.: US 2023/0163462 A1
(43) Pub. Date: May 25, 2023

(54) ANTENNA DEVICE WITH IMPROVED RADIATION DIRECTIVITY

(71) Applicant: HUAWEI TECHNOLOGIES CO., LTD., Shenzhen (CN)

(72) Inventors: Ignacio Gonzalez, Munich (DE); Bruno Biscontini, Munich (DE)

(21) Appl. No.: 18/157,702

(22) Filed: Jan. 20, 2023

Related U.S. Application Data
(63) Continuation of application No. PCT/EP2020/070450, filed on Jul. 20, 2020.

(51) Int. Cl. H01Q 3/36

(52) U.S. Cl. CPC H01Q 3/36

(57) ABSTRACT

This disclosure presents an antenna device including one or more arrays of radiating elements, wherein each array may be an end-fire array. The antenna device comprises an array of N radiating elements (N>1) arranged on a common axis. Each radiating element is configured to radiate a radio wave in response to a RF signal fed to the respective radiating element. A reflector is arranged on the common axis to reflect the N radio waves into a main radiating direction. The antenna device comprises a feed structure to feed a RF signal to each radiating element. The RF signal at each radiating element has a respective phase difference relative to the RF signal at a first radiating element. The feed structure comprises one or more phase shifters, for one or more or all radiating elements, to set the phase difference of the RF signal at the respective radiating element.

### CROSS-REFERENCE TO RELATED APPLICATIONS

This application is a continuation of International Application No. PCT/EP2020/070450, filed on Jul. 20, 2020, the disclosure of which is hereby incorporated by reference in its entirety.

### TECHNICAL FIELD

The present disclosure relates to an antenna device. In particular, the disclosure presents an antenna device that includes one or more arrays of radiating elements, wherein each array of radiating elements may be an end-fire array. The one or more arrays, particularly the end-fire arrays, may together form a broadside array of the antenna device. Each array of the antenna device is further designed to have an improved radiation directivity.

### BACKGROUND

With the Long-Term Evolution (LTE) rollout almost complete, operators are preparing their networks for the upcoming 5^{th} generation mobile network (5G). One key technology for enabling this new generation of mobile communications is massive multiple input multiple output (mMIMO) below 6 GHz. Therefore, new antenna devices are needed that integrate mMIMO with passive antenna arrays.

However, several restrictions to the deployment of new antenna devices exist. For instance, regulations in many countries, especially in Europe, are a real limiting factor when rolling out new services and infrastructures, and are likely going to be developed slower than antenna technology.

Thus, to facilitate antenna site acquisition, and to fulfil local regulations regarding antenna site upgrades, the dimensions of any new antenna device should be comparable to legacy antenna devices. In addition, to be able to maintain the mechanical support structures, which are already present at antenna sites, the wind load of any new antenna device should be comparable or equivalent to the currently installed ones. These factors lead to a very strict limitation in width of a new antenna device.

However, the width of an antenna device also influences its radiation directivity. In particular, the directivity of the antenna device is limited by its aperture, and therefore, by its width. This effect becomes particularly critical when several antenna arrays are placed inside the same enclosure of the antenna device.

Antenna arrays placed in a small reflector usually exhibit a broad horizontal beam width (HBM). This is due to the fact that when dipoles, which may be used as radiating elements of the antenna arrays, are placed in a side-by-side configuration on a small reflector, the HBM increases. This increase, reduces the antenna directivity, and therefore needs to be addressed.

Some exemplary approaches address this problem by conforming the HBW using a 90° hybrid. The hybrid provides a small increment in directivity, but does not exploit fully the reduction of the beam width, because it generates side lobes out of the main cuts.

Some other exemplary approaches addressing this problem result in antenna devices with an increased depth (thickness), a reduced gain, or a reduced bandwidth.

### SUMMARY

In view of the above-mentioned challenges and disadvantages of the exemplary approaches, embodiments of the present invention aim to provide an improved antenna device. Thereby, an objective is to improve the directivity of the antenna device, while at the same time not increasing the width of the antenna device, in particular, the width of a reflector of the antenna device. Ideally, it should be possible to even reduce the width. Furthermore, the depth (thickness) of the antenna device should not significantly increase, compared to antenna devices resulting from the exemplary approaches. Moreover, a gain and a bandwidth of the antenna device should also not be reduced.

The objective is achieved by the embodiments of the invention as described in the enclosed independent claims. Advantageous implementations of the embodiments of the invention are further defined in the dependent claims.

In particular, embodiments of the invention may base on a stacking of radiating elements in the normal direction with respect to the antenna reflector (this normal direction is also referred to as the “z-axis” in this disclosure). The radiating elements may be fed and may radiate at the same frequencies, wherein the individual radiating elements may be fed with a phase difference between them (also referred to as “α” in this disclosure). In addition, also an amplitude relation between the radiating elements may be used as another degree of freedom.

A first aspect of the disclosure provides an antenna device comprising: an array of N radiating elements, N being an integer greater than one, the N radiating elements being arranged on a common axis, each radiating element being configured to radiate a radio wave in response to a RF signal being fed to the respective radiating element, a reflector arranged on the common axis and configured to reflect the N radio waves from the N radiating elements into a main radiating direction, a feed structure configured to feed a RF signal to each radiating element, the RF signal at each radiating element having a respective phase difference relative to the RF signal at a first radiating element of the array, wherein the feed structure comprises one or more phase shifters configured, for one or more or all radiating elements of the array, to set the phase difference of the RF signal at the respective radiating element.

Thus, in the antenna device of the first aspect, one or more (particularly N−1) radiating elements may be added to the first radiating element. For instance, they may be added above the first radiating element (i.e., along the common axis, wherein the common axis may be parallel to the z-axis), if the first radiating element is the radiating element located closest to the reflector. However, any radiating element of the array may be considered being the first radiating element.

Further, by controlling the phase difference between the radiating elements, the radiating fields (i.e., the radio waves radiated by the radiating elements) can be made to constructively interfere. The result may be a combined radiation pattern, which is more directive than the radio wave of a simple/single radiating element.

The overall result may be a significant increase in the directivity of the combined radiation pattern of the antenna device. This allows either a miniaturization of the reflector or an increase in coverage and/or an increased signal to interference plus noise ratio (SINR) provided by the antenna device. The phase difference, and potentially an amplitude difference as a further degree of freedom, between the RF signals at the respective radiating elements, may also be used to improve the front to back and cross-polar discrimination of the antenna device.

Notably, the antenna device of the first aspect is described as a transmission (not reception) device. However, it can also be operated as a reception device.

In an implementation form of the first aspect, the N radiating elements and the reflector are positioned such and the phase shifters are configured such that the radio waves radiated by the radiating elements interfere constructively in the main radiating direction.

Thus, the directivity of the antenna device radiation may be improved without sacrificing signal gain.

In an implementation form of the first aspect, the main radiating direction is the direction away from the reflector along the common axis.

In an implementation form of the first aspect, the one or more phase shifters include one or more controllable phase shifters, for adjusting the phase difference of the RF signal at one or more or all of the radiating elements of the array.

Thus, the radio waves of the individual radiating elements can be controlled with respect to each other (i.e., the phase difference(s)), such that the radiation pattern of the antenna device can be adapted as desired.

In an implementation form of the first aspect, the one or more controllable phase shifters are controllable separately for different frequencies.

For instance, a different phase difference may be set for a RF signal or signal component of a first frequency or first frequency band, than for a RF signal or signal component of a second frequency or second frequency band. Thus, the bandwidth of the antenna device may be improved, particularly a broadband antenna device may be enabled.

In an implementation form of the first aspect, each radiating element of the array is arranged in a different plane.

For instance, each radiating element may comprise a planar element arranged in its respective plane, e.g., a PCB substrate on which a radiating structure, e.g., a dipole, is defined.

In an implementation form of the first aspect, the planes are parallel to each other.

Accordingly, the radiating elements may be stacked one after the other along the common axis. The common axis may be parallel to the z-axis, i.e. the radiating elements may be stacked one above the other.

In an implementation form of the first aspect, the radiating elements of the array are arranged concentrically on the common axis.

This may mean that the common axis may run through a center of gravity of each radiating element. The radiating elements of the array may thus be considered collocated.

In an implementation form of the first aspect, each radiating element of the array comprise a dipole; and the feed structure further comprises one or more rotated baluns, wherein each of the one or more rotated baluns is associated with one of the radiating elements of the array and is configured to contribute a phase offset of 180° to the phase difference of said one of the radiating elements relative to the RF signal at the first radiating element of the array.

This may reduce an absolute phase difference that needs to be set, and thus may allow reducing differences in length of feed lines used for different radiating elements. This may also improve the bandwidth of the antenna device. A rotated balun may be referred to as a mirrored balun. A rotated balun may comprise a bend or a curvature, in particular a 180° bend or curvature.

In an implementation form of the first aspect, the feed structure comprises a feed line for each radiating element of the array; and each feed line has a different length than the other feed lines.

The feed lines may run from the reflector upwards (i.e. along the z-axis, for instance, parallel to the common axis) towards the respective radiating element(s).

In an implementation form of the first aspect, one or more feed lines each comprise a meandering line portion.

This allows extending the length of a certain feed line for a certain radiating element, without requiring more space for the feed line along the common axis.

In an implementation form of the first aspect, the RF signal at one or more radiating elements has a respective amplitude difference relative to the RF signal at the first radiating element of the array.

The amplitude difference(s) may be used as a further degree of freedom, in particular, for influencing the radiation pattern of the antenna device, for instance, the directivity of the radiation of the antenna device.

In an implementation form of the first aspect, the feed structure further comprises one or more power splitters, for one or more or all radiating elements of the array, to set the amplitude difference of the RF signal at the respective radiating element.

The power splitters may be controllable power splitters, for adjusting the amplitude difference of the RF signal at one or more or all of the radiating elements of the array.

In an implementation form of the first aspect, the feed structure is configured to feed two or more radiating elements of the array from two or more different sources or separately from the same source.

For instance, for a mMIMO antenna device, the radiating elements may be fed from two or more different sources.

In an implementation form of the first aspect, the feed structure is configured to feed the radiating elements of the array in parallel.

Thereby, the radiating elements of the array may all be fed with the same RF signal, wherein the phase differences are applied between the RF signals provided to the respective radiating elements compared to the RF signal provided to the first radiating element.

In an implementation form of the first aspect, one or more radiating elements of the array are, respectively, surrounded by a conductive ring.

This may increase the bandwidth of the radiating element, and thus of the entire antenna device.

In an implementation form of the first aspect, the antenna device further comprises a conductive structure, in particular a ring-like structure, arranged between two adjacent radiating elements of the array.

This conductive structure may be used to modify the phase in near field, and may allow coupling between radiating elements.

In an implementation form of the first aspect, one or more radiating elements of the array are dual-polarized radiating elements.

In an implementation form of the first aspect, a radiating element closer to the reflector has a larger radiating area than a radiating element further away from the reflector along the common axis.

This may be beneficial for certain types of arrays formed by the radiating elements, for instance, end-fire arrays.

In an implementation form of the first aspect, the antenna device the array of the N radiating elements is an end-fire array.

In an implementation form of the first aspect, the antenna device further comprises a support structure configured to hold each radiating element of the array, such that the N radiating elements are all arranged on the common axis.

In an implementation form of the first aspect, each radiating element has a different defined distance from the first radiating element of the array.

In an implementation form of the first aspect, the antenna device further comprises: a further array of M radiating elements, M being an integer greater than one, the M radiating elements being arranged on another common axis, each radiating element of the further array being configured to radiate a radio wave in response to a RF signal being fed to the respective radiating element of the further array; and a further feed structure configured to feed a RF signal to each radiating element of the further array, the RF signal at each radiating element of the further array having a respective phase difference relative to the RF signal at a first radiating element of the further array, wherein the further feed structure comprises one or more phase shifters configured, for one or more or all radiating elements of the further array, to set the phase difference of the RF signal at the respective radiating element of the further array; wherein the array of N radiating elements and the array of M radiating elements are arranged to form a broadside array of the antenna device.

The reflector may be also arranged on the another common axis, and may be configured to reflect the M radio waves from the M radiating elements of the further array into the main radiating direction.

In particular, the two arrays of the M and N radiating elements, respectively, and one or more additional arrays of radiating elements formed and configured in the same manner, e.g., as end-fire arrays, may be used to form the broadside array of the antenna device. Each of the two or more arrays may thereby have the same number of radiating elements, or a different number of radiating elements. Accordingly, M may be equal to N, but may also be different than N.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an antenna device according to an embodiment of the invention.

FIG. 2 shows an antenna device according to an embodiment of the invention.

FIG. 3 shows an antenna device according to an embodiment of the invention.

FIG. 4 shows a perspective view of an antenna device according to an embodiment of the invention.

FIG. 5 shows a top view of the antenna device of FIG. 4.

FIG. 6 shows a side view of the antenna device of FIGS. 4 and 5.

### DETAILED DESCRIPTION OF EMBODIMENTS

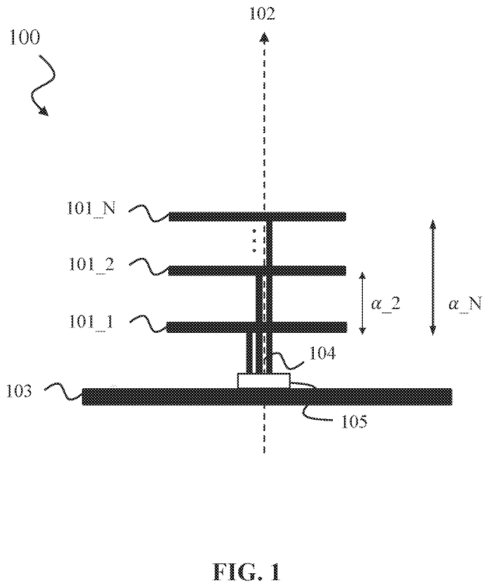

FIG. 1 shows an antenna device 100 according to an embodiment of the invention. In particular, the antenna device 100 may be a broadband antenna device, and/or may be an antenna device that is suitable for mMIMO. The antenna device 100 is designed to have an improved radiation directivity.

The antenna device 100 comprises an array of N radiating elements 101 (wherein N is an integer greater than one, e.g., N may be 2, 3 or 4). The N radiating elements 101 are arranged on a common axis 102, wherein the common axis 102 may be (but does not have to be) parallel to the z-axis (i.e., the normal to the plane of a reflector 103). Each of the N radiating elements 101 is configured to radiate a radio wave in response to a RF signal, which is fed to that radiating element 101. One or more of the radiating elements 101, or each radiating element 101, may to this end comprise a dipole. For example, one or more radiating elements 101, or each radiating element 101, may be a dual-polarized radiating element 101.

Further, the antenna device 100 comprises the reflector 103, which is arranged on the common axis 102, and is configured to reflect the N radio waves from the N radiating elements 101 into a main radiating direction of the antenna device 100. The main radiation direction may be along the common axis 102 and/or the z-axis.

Further, the antenna device 100 comprises a feed structure 104, which is configured to feed a RF signal to each radiating element 101. The RF signal that is fed to each radiating element 101 may be the same RF signal. The RF signal at each radiating element 101 has a respective phase difference α relative to the RF signal at a first radiating element 101 of the array. The first radiating element 101 of the array may be any of the radiating elements 101, but typically it is the radiating element 101 closest to the reflector 103.

The feed structure 104 comprises one or more phase shifters 105 configured, for one or more or all radiating elements 101 of the array, to set the phase difference a of the RF signal at the respective radiating element 101. For instance, the feed structure 104 may comprise a phase shifter 105 for each radiating element 101. One or more phase shifters 105, or each phase shifter 105, may be a controllable phase shifter 105, which can be controlled for adjusting the phase difference α of the RF signal at one or more or all radiating elements 101 of the array. Each phase shifter 105 may either be a digital or an analog phase shifter.

For instance, in the antenna device 100 shown in FIG. 1, a first radiating element 101_1 may fed with the RF signal. One or more additional radiating elements 101_2 . . . 102_N may be placed one after the other next to the first radiating element 101_1, i.e., all radiating elements 101 may be arranged on the common axis 102. The one or more additional radiating elements 101_2 . . . 101_N are fed with a respective RF signal having a respective phase difference α_2 . . . α_N relative to the RF signal at the first radiating element 101_1 of the array. In addition, amplitude differences could be likewise applied to the respective RF signals.

By controlling the phase difference(s) α, the HBW of the antenna device 100 can be controlled. In particular, an optimum HBW can be achieved (i.e., a maximum directivity can be achieved). Specifically, the directivity can be improved by up to 1.5 dBs compared to antenna devices according to the exemplary approaches. As the phase difference(s) between the radiating elements 101 change(s), so does the antenna device 100 HBW. Furthermore, more radiating elements 101 could always be added for providing additional degrees of freedom. This concept of the antenna device 100 may also be used to improve its cross polar discrimination and the front to back ratio. Notably, all radiating elements 101 may be fed in parallel, and the phase difference(s) and optionally amplitude difference(s) can be arbitrarily selected.

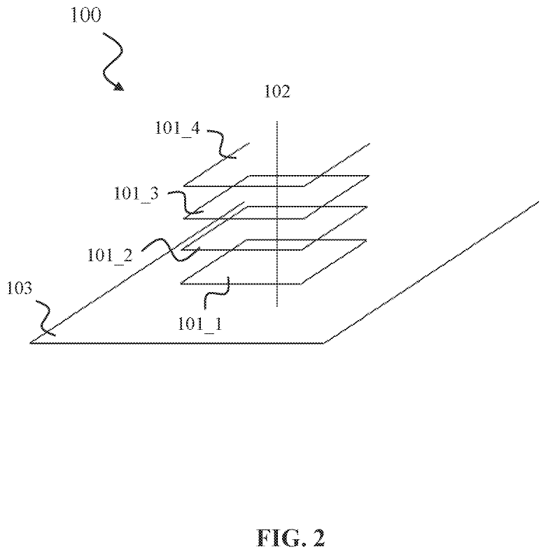

FIG. 2 shows an antenna device 100 according to an embodiment of the invention, which builds on the embodiment shown in FIG. 1. Same elements in FIG. 1 and FIG. 2 are labelled with the same reference signs, and may be implemented likewise.

In particular, FIG. 2 illustrates in a three-dimensional (3D) view that the N radiating elements 101 (here four radiating elements 101_1 . . . 101_4 are exemplarily shown) may be concentrically arranged on the common axis 102. The N radiating elements 101 may in this manner be stacked along the common axis 102, particularly, along the z-axis. The N radiating elements 101 may thereby form an end-fire array. As indicated in FIG. 2, each radiating element 101 may be arranged in a different plane above (i.e., along the z-axis) the reflector 103. The planes may be equidistant and parallel, but also different distances may be applied between the planes. Each radiating element 101 may have the same radiating area, as indicated in FIG. 2. However, typically, a radiating element 101 closer to the reflector 103 may have a larger radiating area than a radiating element 101 further away from the reflector 103 along the common axis 102.

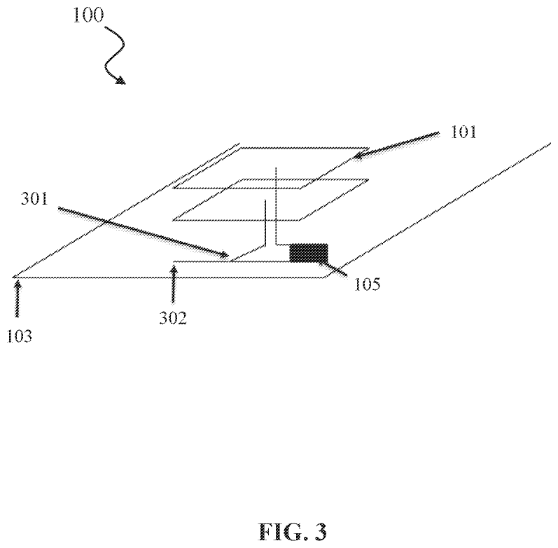

FIG. 3 shows an antenna device 100 according to an embodiment of the invention, which builds on the embodiments shown in FIG. 1 and FIG. 2. Same elements in FIGS. 1, 2 and 3, respectively, are labelled with the same reference signs, and may be implemented likewise.

In particular, FIG. 3 shows that the feed structure 104 may comprises a feed line 301 for each radiating element 101 of the array. Thereby, each feed line 301 may have a different length than the other feed lines 301. FIG. 3 further shows that the different feed lines 301 may be fed and/or may branch off from a combined port 302 (may be a common feeding point for the array of radiating elements 101, in particular, if each radiating element 101 is fed the same RF signal).

Further, one phase shifter 105 may be used per feed line 301 to affect the phase of an RF signal provided via that feed line 301. However, one phase shifter 105 may also affect multiple feed lines 301 as shown in FIG. 3. Each feed line 301 may further have a different length than the other feed lines 301, since the feed lines 301 feed radiating elements 101 at different defined distances from the reflector 103 (the feed lines 301 may run from the reflector 103 along the common axis 102 to the respective radiating elements 101).

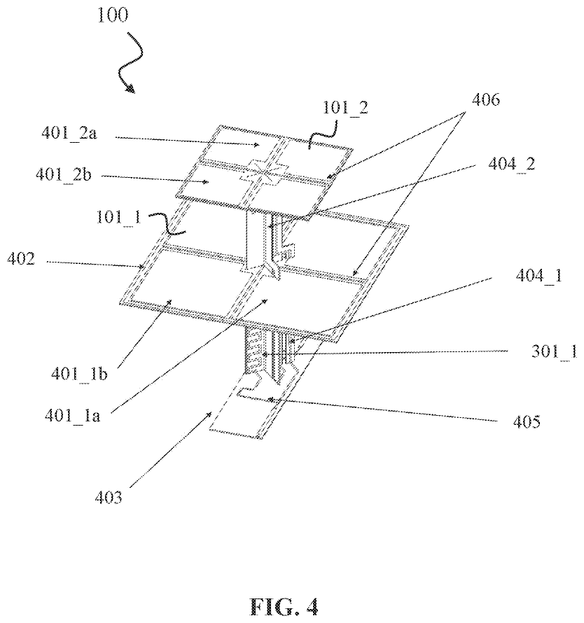

FIGS. 4, 5 and 6 show an antenna device 100 according to an exemplary embodiment of the invention, which builds on the antenna device 100 of FIG. 1, 2 or 3. Same elements shown in the figures are labelled with the same reference signs, and may be implemented likewise.

The antenna device 100 according to the exemplary embodiment comprises two stacked radiating elements 101 (i.e., here N=2). Each of the radiating elements 101 comprises a dipole. FIG. 2 also shows the feed structure 104.

In particular, FIGS. 4, 5 and 6 show two radiating elements 101_1 and 101_2. The bottom radiating element 101_1 comprises a bottom dipole, and the top radiating element 101_2 comprises a top dipole (see FIG. 4). Each radiating element 101 specifically comprises a Printed Circuit Board (PCB) substrate 406 on which the respective dipole is defined. The top radiating element 101_2 comprises a top dipole arm 401_2a for a first polarization, and a top dipole arm 401_2b for a second polarization. These polarizations may be orthogonal. The top dipole arms 401_2a and 401_2b are defined in the PCB substrate 406 of the top radiating element 101_2. The antenna device 100 may also comprise a top dipole balun 404_2 for the top dipole. Further, the bottom radiating element 101_2 comprises a bottom dipole arm 401_1a for the first polarization, and a bottom dipole arm 401_1b for the second polarization. The bottom dipole arms 401_1a and 401_1b are defined in the PCB substrate 406 of the bottom radiating element 101_1. The antenna device 100 may comprise a bottom dipole balun 404_1 for the bottom dipole.

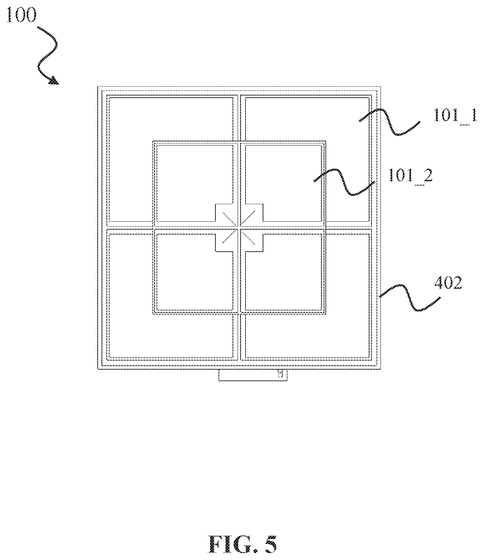

The bottom radiating element 101_1 may have a larger radiating area than the top radiating element 101_2, and accordingly, may have dipole arms of different lengths (see FIG. 5). The bottom radiating element 101_1 further comprises a conductive ring 402, in particular, it is surrounded by a conductive ring 402. The conductive ring 402 may be used for matching and beam width improvement. Notably, also the top radiating element 101_2 could be surrounded by such a conductive ring 402.

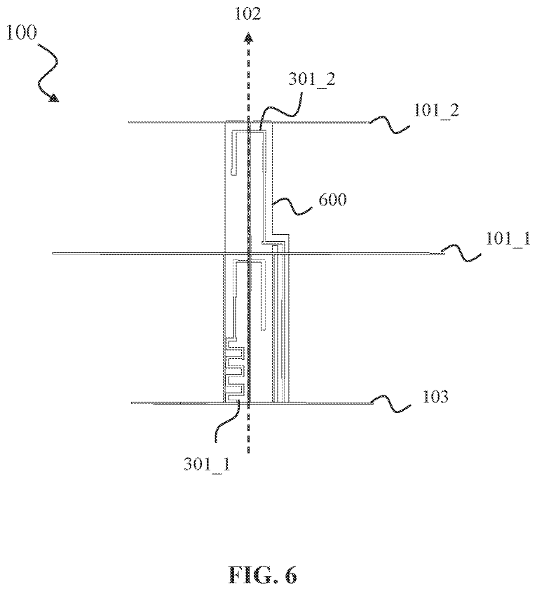

Further, the antenna device 100 comprises a base PCB substrate 403. The reflector 103 may be provided on the base PCB substrate 403, e.g., on the bottom side as metallization. On the base PCB substrate 403, the antenna device 100 may further comprise a power splitter 405 to control an amplitude difference between the two radiating elements 101_1 and 101_2. The power splitter 405 may be arranged between feed lines 301_1 and 301_2 for the lower radiating element 101_1 and upper radiating element 101_2, respectively. A phase shifter 105 (not shown) controls the phase difference a. Further, at least one of the feed lines 301_1 and 301_2 may have a meandering line portion. Here the feed line 301_1 for the lower radiating element 101_1 comprises a meandering line portion (see FIG. 6) to additionally add to the phase difference α.

The antenna device 100 also comprise a support structure 600 configured to hold each radiating element 101 of the array such that the radiating elements 101 are all arranged on the common axis 102. The support structure 600 may be or comprise a PCB, on which the feeding lines 301 are arranged.

In the exemplary embodiment of FIGS. 4, 5 and 6, the phase difference α between the radiating elements 101_1 and 101_2 can be chosen to be 240°. As an additional feature, the balun 404_2 of the top dipole (of radiating element 101_2) may be rotated (or mirrored) to provide 180° phase offset (see FIG. 6), therefore reducing the difference in length required between the feeding lines 301_1 and 301_2 of the top and bottom dipoles (radiating elements 101_1 and 101_2). Thus, the feed structure 104 may comprise one or more rotated baluns, wherein each of the one or more rotated baluns is associated with one of the radiating elements 101 of the array. Each rotated balun may be configured to contribute a phase offset of 180° to the phase difference α of said one of the radiating elements 101 relative to the RF signal at the first radiating element of the array. As a result, also a phase dispersion with frequency may be reduced, so that the radiation pattern of the antenna device 100 is more stable with frequency and the bandwidth may be effectively increased.

In summary, embodiments of the invention provide a novel approach for increasing the directivity of an array of radiating elements 101 and thus the antenna device 100, without increasing the width of the reflector 103. The embodiments of the invention allows tuning the HBW of the antenna device 100 to desired values. Further, the embodiments of the invention allow an improvement of the front to back and cross-polar discrimination when more than two radiating elements 101 are used. The embodiments of the invention further allow a height reduction of the antenna device 100 compared to other antenna architectures.

In the antenna device 100, a phase difference α, an amplitude difference, and a distance between each of N radiating elements 101 may be are used as degrees of freedom to improve the antenna device 100 performance. The assembly of the antenna device 100 is fairly easy and may use standard materials and processes. The resulting antenna device 100 may be broadband enough to support current bands in base stations, particularly of 5G base stations.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An antenna device comprising:
an array of N radiating elements, N being an integer greater than one, the N radiating elements being arranged on a common axis, each radiating element being configured to radiate a radio wave in response to a radiofrequency, RF, signal being fed to the respective radiating element;
a reflector arranged on the common axis and configured to reflect the N radio waves from the N radiating elements into a main radiating direction;
a feed structure configured to feed a RF signal to each radiating element, the RF signal at each radiating element having a respective phase difference relative to the RF signal at a first radiating element of the array, wherein the feed structure comprises one or more phase shifters configured, for one or more or all radiating elements of the array, to set the phase difference of the RF signal at the respective radiating element.

2. The antenna device of claim 1, wherein the N radiating elements and the reflector are positioned such and the phase shifters are configured such that the radio waves radiated by the radiating elements interfere constructively in the main radiating direction.

3. The antenna device of claim 1, wherein the main radiating direction is the direction away from the reflector along the common axis.

4. The antenna device (100) of claim 1, wherein the one or more phase shifters include one or more controllable phase shifters, for adjusting the phase difference (α) of the RF signal at one or more or all of the radiating elements of the array.

5. The antenna device according to the claim 1, wherein:
each radiating element (101) of the array is arranged in a different plane.

6. The antenna device according to claim 1, wherein:
the radiating elements of the array are arranged concentrically on the common axis.

7. The antenna device according to the claim 1, wherein:
each radiating element of the array comprise a dipole; and
the feed structure further comprises one or more rotated baluns, wherein each of the one or more rotated baluns is associated with one of the radiating elements of the array and is configured to contribute a phase offset of 180° to the phase difference of said one of the radiating elements relative to the RF signal at the first radiating element of the array.

8. The antenna device according to the claim 1, wherein:
the feed structure comprises a feed line for each radiating element of the array; and
each feed line has a different length than the other feed lines (301).

9. The antenna device according to claim 7, wherein:
one or more feed lines each comprise a meandering line portion.

10. The antenna device according to the claim 1, wherein:
the RF signal at one or more radiating elements has a respective amplitude difference relative to the RF signal at the first radiating element of the array.

11. The antenna device according to claim 10, wherein the feed structure further comprises:
one or more power splitters, for one or more or all radiating elements of the array, to set the amplitude difference of the RF signal at the respective radiating element.

12. The antenna device according to the claim 1, wherein:
the feed structure is configured to feed two or more radiating elements of the array from two or more different sources or separately from the same source.

13. The antenna device according to the claim 1, wherein:
the feed structure is configured to feed the radiating elements of the array in parallel.

14. The antenna device according to the claim 1, wherein:
one or more radiating elements of the array are, respectively, surrounded by a conductive ring.

15. The antenna device according to the claim 1, further comprising:
a conductive structure, in particular a ring-like structure, arranged between two adjacent radiating elements of the array.

16. The antenna device according to one of the claim 1, wherein:
a radiating element closer to the reflector has a larger radiating area than a radiating element further away from the reflector along the common axis.

17. The antenna device according to the claim 1, wherein:
the array of the N radiating elements is an end-fire array.

18. The antenna device according to the claim 1, further comprising:
a support structure configured to hold each radiating element of the array such that the radiating elements (101) are all arranged on the common axis.

19. The antenna device according to claim 1, wherein:
each radiating element has a different defined distance from the first radiating element of the array.

20. The antenna device according to the claim 1, comprising:
a further array of M radiating elements, M being an integer greater than one, the M radiating elements being arranged on another common axis, each radiating element of the further array being configured to radiate a radio wave in response to a RF signal being fed to the respective radiating element of the further array; and
a further feed structure configured to feed a RF signal to each radiating element of the further array, the RF signal at each radiating element of the further array having a respective phase difference relative to the RF signal at a first radiating element of the further array, wherein the further feed structure comprises one or more phase shifters configured, for one or more or all radiating elements of the further array, to set the phase difference of the RF signal at the respective radiating element of the further array;
wherein the array of N radiating elements and the further array of M radiating elements are arranged to form a broadside array of the antenna device.
